(19) United States
(12) Patent Application Publication
(10) Pub. No.: US 2005/0010822 A1
(43) Pub. Date: Jan. 13, 2005

(54) Firewall and method for configuring same

(76) Inventors: Xinyu Zhou, Shenzhen (CN); Tang He, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/837,482

(22) Filed: Apr. 29, 2004

(30) Foreign Application Priority Data
Jul. 9, 2003 (TW) 92118774

(51) Int. Cl. H04L 9/00

(52) U.S. Cl. 713/201

(57) ABSTRACT

A firewall includes a user interface (21) for inputting a configuration command; a shared library (25) providing information packet filtering and management application programming interfaces; a configuration management module (23) for finding out which service is responsible for the configuration command, and a kernel component (27) for performing packet filtering, network address translation and port address translation. The firewall further comprises an access database (251) for storing access lists and access rules, a NAT database (252) for storing rules on network address translation, an interface database (253) for storing information on interfaces of the firewall of the present invention, and a pool database (254) for storing NAT pool lists. A related method for configuring the firewall is also disclosed.

### BACKGROUND OF THE INVENTION

1. Field of the Invention

The present invention relates to firewalls and methods of configuring firewalls.

2. Background of the Invention

Today, many people use personal computers both at their place of work and in their homes. These computers are used for many purposes including word processing, maintaining accounts and inventory records, playing games and educational enrichment. As a result of the popularity of personal computers, the cost of owning a computer has gone down to very affordable levels. The general availability of personal computers has spawned the popularity of the Internet and services marketed online. Files or other resources on computers around the world may be publicly available to users of other computers through the collection of networks known as the Internet. The collection of all such publicly available resources, linked together using files written in Hypertext Mark-up Language (HTML), is known as the World Wide Web (WWW).

A firewall is a security system designed to prevent unauthorized access from the WWW network to a private or local network. The security system can either be a hardware firewall or a software firewall, or a combination thereof.

Currently, firewall products are generally complicated in structure and cumbersome to configure. For instance, China Pat. No. 97115121.0 discloses a private group filtering firewall, which comprises a group filter, a system manager, a safety controller, and a card reader with a slot. The group filter is connected between the Internet and a router. The safety controller is connected between the system manager and the Internet, for protecting the system manager against unauthorized access. The card reader is connected to the system manager. When the system manager is used to configure control parameters of the firewall, a security card is inserted into the slot of the card reader, and a string of personal identification number (PIN) codes is input.

Although the above-mentioned firewall provides improved security, its configuration is unduly inconvenient because of the need for the safety card and the inputting of the string of PIN codes. Therefore, a firewall system and configuration method therefor which overcome the above-mentioned shortcomings is desired.

### SUMMARY OF THE INVENTION

Accordingly, an object of the present invention is to provide a firewall that can be configured conveniently.

Another object of the present invention is to provide a method for conveniently configuring a firewall.

In order to accomplish the above-mentioned first object, a preferred embodiment of a firewall comprises: a user interface for a user to enter a configuration command; a shared library providing information packet filtering and management application programming interfaces; a configuration management module for finding out which service is responsible for the configuration command, and for calling a corresponding application programming interface; and a kernel component for performing packet filtering, network address translation and port address translation. The firewall further comprises an access database for storing access lists and access rules, a NAT database for storing rules on network address translation, an interface database for storing information on interfaces of the firewall of the present invention, and a pool database for storing network address translation pool lists.

In order to accomplish the above-mentioned second object, a preferred method for configuring a firewall comprises the steps of: entering a configuration command via a user interface; submitting the configuration command to a configuration management module; transmitting the configuration command to a shared library, wherein the shared library providing information packet filtering and management application programming interfaces; determining whether the configuration command is legal; processing the configuration command if the configuration command is legal for removing redundant character therein, such as tabs and blanks; parsing the configuration command to a predetermined rule; executing the configuration command for configuring the firewall; and returning configuration results to the user interface.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware structure of a firewall in accordance with the preferred embodiment of the present invention;

FIG. 2 is a schematic diagram of software structure of the firewall in FIG. 1; and

FIG. 3 is a flow chart of a method of configuring the firewall in accordance with a preferred embodiment of the present invention.

### DETAILED DESCRIPTION OF PREFERRED EMBODIMENTS OF THE INVENTION

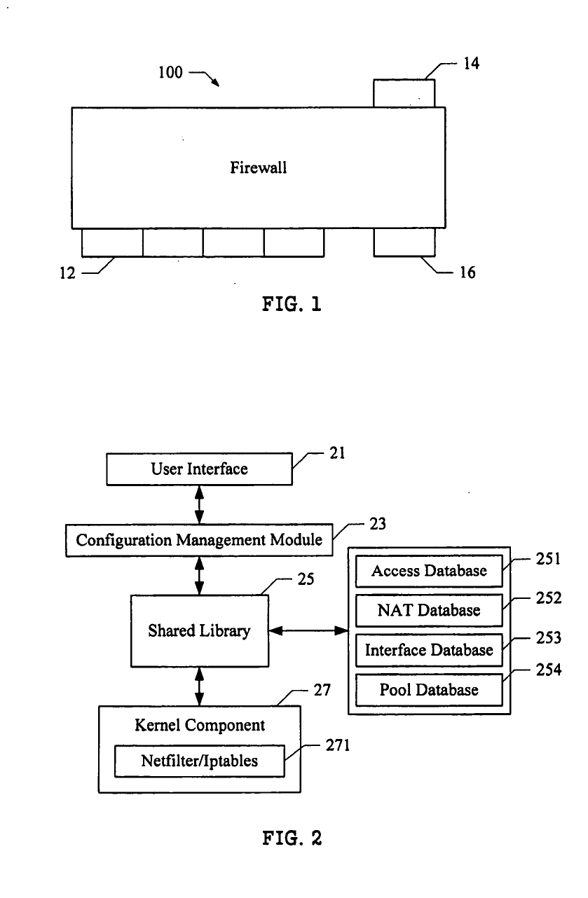

FIG. 1 is a schematic diagram of hardware structure of a firewall 100 in accordance with the preferred embodiment of the present invention. The hardware structure of the firewall 100 comprises one or more of the following three network ports: a local area network (LAN) port 12, a wide area network (WAN) port 14, and a demilitarized zone (DMZ) port 16. The LAN port 12 is provided for connecting to internal area networks of an organization. The WAN port 14 is used for connecting to exterior wide area networks. The DMZ port 16 is configured for connecting to exterior networks employing DMZ-structured firewalls.

FIG. 2 is a schematic diagram of software structure of the firewall 100. The software structure of the firewall 100 comprises a user interface 21, a configuration management module 23, a shared library 25, and a kernel component 27.

The user interface 21 is configured for users to interact with the firewall 100, such as by entering configuration commands and receiving configuration results. The user interface 21 may be a command line interface (CLI), or a web based graphic user interface (GUI). The configuration management module 23 is used for finding out which service is responsible for the configuration command, and for calling a corresponding application programming interface (API) based on the configuration command in order to perform the configuration command.

The shared library 25 provides information packet filtering and management APIs. The management APIs can invoke various functions to perform configuration-related operations, such as preprocessing configuration commands, opening or closing databases, parsing configuration commands, and performing configuration commands.

The kernel component 27 is an information packet filtering system, which is a portion of and embedded in the Linux® kernel. The kernel component 27 performs the operations of packet filtering, network address translation (NAT), and port address translation (PAT). The kernel component 27 is composed of netfilter and information packet tables (iptables) 271. The information packet tables 271 comprise collections of rules that are used for controlling the processing of information packets.

The software structure of the firewall 100 further comprises an access database 251, a network address translation (NAT) database 252, an interface database 253 and a pool database 254, all of which are maintained by the shared library 25. The access database 251 is provided for storing access lists and access rules. The NAT database 252 is used for storing rules on network address translation. NAT is designed for IP address simplification and conservation, as it enables private IP inter-networks that use unregistered IP addresses to connect to the Internet. The NAT operates on a router that usually connecting two networks together. NAT translates the private (not globally unique) addresses in an internal network into legal addresses before packets are forwarded onto another network. The interface database 253 stores information on interfaces of the firewall 100. The pool database 254 stores NAT pool lists. The NAT pool lists are configured at the router by defining a pool of addresses using start address, end address, and subnet mask. These addresses are subsequently allocated as needed.

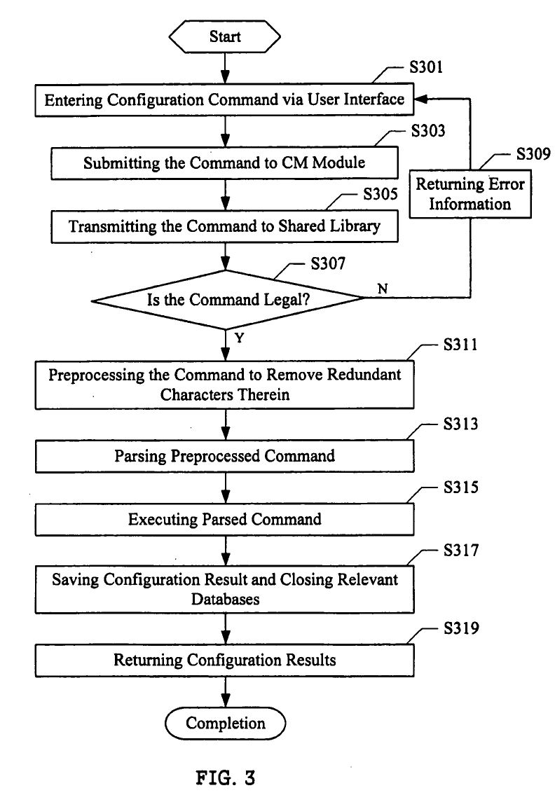

FIG. 3 is a flow chart of a preferred method of configuring the firewall 100. At step S301, a user inputs a configuration command via the user interface 21. At step S303, the user interface 21 submits the configuration command to the configuration management module 23. At step S305, the configuration management module 23 transmits the configuration command to the shared library 25. At step S307, the management API of the shared library 25 invokes a preprocessing function to determine whether the configuration command is legal, based on access rules in the access database 251. If the configuration command is not legal, at step S309, the shared library 25 returns error information to the user interface 21 through the configuration management module 23, and the procedure goes back to step S301. If the configuration command is legal, at step S311, the shared library 25 preprocesses the configuration command by use of the preprocessing function. This removes redundant characters in the configuration command, such as tabs and blanks. At step S313, the management API of the shared library 25 invokes a parse function to parse the preprocessed command to a predetermined rule, such as a rule that is understandable by an operating system (OS) of the firewall 100. For example, if the operating system of the firewall 100 is a Linux platform, the parsed configuration command should be Linux-understandable. At step S315, the management API of the shared library 25 invokes a perform function to execute the parsed command and thereby configure the firewall 100. After completing the configuration, at step S317, the firewall 100 saves configuration results and closes relevant databases. At step S319, the shared library 25 returns the configuration results to the user interface 21.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

1. A firewall system, comprising:
a user interface for a user to enter a configuration command;
a shared library providing information packet filtering and management application programming interfaces;
a configuration management module for finding out which service is responsible for the configuration command, and for calling a corresponding application programming interface; and
a kernel component for performing packet filtering, network address translation and port address translation.

2. The firewall system as recited in claim 1, wherein the user interface is a command line interface.

3. The firewall system as recited in claim 1, wherein the user interface is a web based graphic user interface.

4. The firewall system as recited in claim 1, further comprising an access database for storing access lists and access rules.

5. The firewall system as recited in claim 1, further comprising a network address translation database for storing rules on network address translation.

6. The firewall system as recited in claim 1, further comprising an interface database for storing information on interfaces of the firewall.

7. The firewall system as recited in claim 1, further comprising a pool database for storing network address translation pool lists.

8. A method for configuring a firewall, the method comprising the steps of:
entering a configuration command via a user interface;
transmitting the configuration command to a shared library, the shared library providing information packet filtering and management application programming interfaces;
determining whether the configuration command is legal;
processing the configuration command if the configuration command is legal; and
executing the configuration command for configuring the firewall.

9. The method as recited in claim 8, wherein the user interface is a command line interface.

10. The method as recited in claim 8, wherein the user interface is a web based graphic user interface.

11. The method as recited in claim 8, further comprising the step of:
submitting the configuration command to a configuration management module, for the configuration management module to find out which service is responsible for the configuration command.

12. The method as recited in claim 8, wherein the step of determining whether the configuration command is legal further comprises the step of:
returning error information if the configuration command is not legal.

13. The method as recited in claim 8, wherein the step of processing the configuration command further comprises the step of:
parsing the configuration command to a predetermined rule.

14. The method as recited in claim 8, further comprising the steps of:
saving configuration results; and
returning the configuration results to the user interface.
